(19) United States
(12) Patent Application Publication
(10) Pub. No.: US 2026/0081632 A1
(43) Pub. Date: Mar. 19, 2026

(54) CASCADED COUPLED PORTS FOR IOT AND WI-FI COEXISTENCE IMPROVEMENTS

(71) Applicant: Qorvo US, Inc., Greensboro, NC (US)

(72) Inventors: Chris Levesque, Fountain Valley, CA (US); Yilong Shen, Nijmegen (NL)

(21) Appl. No.: 19/304,677

(22) Filed: Aug. 20, 2025

Related U.S. Application Data
(60) Provisional application No. 63/695,425, filed on Sep. 17, 2024.

(51) Int. Cl. H04B 1/10; H01P 5/18; H04B 1/38

(52) U.S. Cl. CPC H04B 1/1027; H01P 5/18; H04B 1/38

(57) ABSTRACT

Embodiments of a system include a first transceiver, a first directional coupler, a first antenna, a second directional coupler, a second antenna, a second transceiver, a third transceiver, and a third directional coupler. The first directional coupler is connected to the first transceiver. The first antenna is connected to the first directional coupler. The second antenna is connected to the second directional coupler. The second transceiver is connected to the second directional coupler. The third transceiver has an antenna port. The third directional coupler is connected to the antenna port of the third transceiver and the other directional couplers. The first directional coupler, the second directional coupler, and the third directional coupler are configured to reduce interference that is incurred between the antenna port of the third transceiver and the first and the second transceivers.

### RELATED APPLICATIONS

This application claims the benefit of provisional patent application serial number 63/695,425, filed September 17, 2024, the disclosure of which is hereby incorporated herein by reference in its entirety.

### FIELD OF THE DISCLOSURE

The technology of the disclosure relates generally to mitigating interference from co-located antennas in a device supporting one or more wireless technologies.

### BACKGROUND

Mobile communication devices have become increasingly common in current society for providing wireless communication services. The prevalence of these mobile communication devices is driven in part by the many functions that are now enabled on such devices. Increased processing capabilities in such devices means that mobile communication devices have evolved from being pure communication tools into sophisticated mobile multimedia centers that enable enhanced user experiences.

Many mobile communication devices support multiple transceivers that may operate according to different wireless technologies. For example, it is common for a smart phone to include a WI-FI transceiver, a BLUETOOTH transceiver (including modern variants such as a BLUETOOTH Low Energy (BLE) transceiver), a ZIGBEE® transceiver, a cellular transceiver, and the like. While the presence of these multiple transceivers increases the versatility and functionality of the mobile communication device, the multiple transceivers can create problems for one another.

Specifically, the antennas associated with these transceivers must be located proximate to one another given the limited real estate of the mobile communication device. When the antennas are proximate to one another, a signal being transmitted from one antenna may couple to a proximate antenna, which can cause interference with signals being received by the proximate antenna.

### SUMMARY

Embodiment 1. A system, includes: a first transceiver; a first directional coupler operably connected to the first transceiver; a first antenna operably connected to the first directional coupler; a second directional coupler; a second antenna operably connected to the second directional coupler; a second transceiver operably connected to the second directional coupler; a third transceiver having an antenna port; and a third directional coupler operably connected to the antenna port of the third transceiver, the first directional coupler, and the second directional coupler, wherein the first directional coupler, the second directional coupler, and the third directional coupler are configured to reduce interference that is incurred between the antenna port of the third transceiver and the first transceiver and the second transceiver.

Embodiment 2. The system of embodiment 1, further includes: a first tunable load operably connected to the first directional coupler, wherein the first directional coupler, the second directional coupler, and the third directional coupler being configured to reduce the interference includes the first tunable load being tunable to reduce the interference between the first transceiver and the antenna port; and a second tunable load operably connected to the second directional coupler, wherein the first directional coupler, the second directional coupler, and the third directional coupler being configured to reduce the interference includes the second tunable load being tunable to reduce the interference between the second transceiver and the antenna port.

Embodiment 3. The system of embodiment 2, further includes a termination load, wherein the first directional coupler, the second directional coupler, and the third directional coupler being configured to reduce the interference includes the termination load being coupled to the third directional coupler.

Embodiment 4. The system of embodiment 3, wherein: the first directional coupler has a first line and a second line; the first line is electromagnetically coupled to the second line; a first port is at a first end of the first line; a second port is at a second end of the first line; a third port is at a third end of the second line; a fourth port is at a fourth end of the second line; the first transceiver is coupled to the first port; the first antenna is coupled to the second port; the first tunable load is coupled to the third port; and the fourth port is coupled to the third directional coupler.

Embodiment 5. The system of embodiment 4, wherein: the second directional coupler has a third line and a fourth line; the third line is electromagnetically coupled to the fourth line; a fifth port is at a fifth end of the third line; a sixth port is at a sixth end of the third line; a seventh port is at a seventh end of the fourth line; an eighth port is at an eighth end of the fourth line; the second transceiver is coupled to the fifth port; the second antenna is coupled to the sixth port; the second tunable load is coupled to the seventh port; and the eighth port is coupled to the third directional coupler.

Embodiment 6. The system of embodiment5, wherein the termination load is a first termination load and wherein the system further includes a second termination load, wherein: the third directional coupler has a fifth line and a sixth line; the fifth line is electromagnetically coupled to the sixth line; a ninth port is at a ninth end of the fifth line; a tenth port is at an tenth end of the fifth line; an eleventh port is at a eleventh end of the sixth line; a twelfth port is at a twelfth end of the sixth line; the ninth port is operably connected to the eighth port; the tenth port is coupled to the second termination load; the eleventh port is operably connected to the antenna port; and the twelfth port is connected to the fourth port.

Embodiment 7. The system of embodiment 3, further includes: a fourth transceiver; a fourth directional coupler operably connected to the fourth transceiver; a fourth antenna operably connected to the fourth directional coupler; and a fifth directional coupler, wherein the first directional coupler and the fourth directional coupler are coupled to the third directional coupler through the fifth directional coupler.

Embodiment 8. The system of embodiment 1, further includes: a first tunable load operably connected to the first directional coupler, wherein the first directional coupler, the second directional coupler, and the third directional coupler being configured to reduce the interference includes the first tunable load being tunable to reduce the interference between the first transceiver and the antenna port; a second tunable load; and an isolator, wherein the second tunable load is operably connected to the third directional coupler and the isolator is connected between the second directional coupler and the third directional coupler, wherein the first directional coupler, the second directional coupler, and the third directional coupler being configured to reduce the interference includes the second tunable load being tunable to reduce the interference between the second transceiver and the antenna port and the isolator being configured to reduce reflections between the second directional coupler and the third directional coupler.

Embodiment 9. The system of embodiment 1, further includes: a first tunable load operably connected to the first directional coupler, wherein the first directional coupler, the second directional coupler, and the third directional coupler being configured to reduce the interference includes the first tunable load being tunable to reduce the interference between the first transceiver and the antenna port; and an adjustment impedance, wherein the adjustment impedance is operably connected between the second directional coupler and the third directional coupler, wherein the first directional coupler, the second directional coupler, and the third directional coupler being configured to reduce the interference includes the adjustment impedance being tunable to reduce the interference between the second transceiver and the antenna port by adjusting a phase and magnitude of an impedance of the adjustment impedance.

Embodiment10. The system of embodiment 1, wherein the antenna port of the third transceiver is a first antenna port, wherein the third transceiver further includes a second antenna port, and wherein the system the further includes and a control circuit configured to switch the third transceiver between the first antenna port and the second antenna port.

Embodiment 11. A method of selecting an antenna of a victim transceiver in response to a power level of one or more aggressor transceivers, the method includes: measuring the power level of one or more transmit signals transmitted by a first antenna coupled to a first transceiver through a first directional coupler and a second antenna coupled to a second transceiver through a second directional coupler; receiving a receive signal from a third antenna at a third transceiver in response to the power level of the one or more transmit signals being below a threshold level; reducing interference that is incurred between the one or more aggressor transceivers and an antenna port of the third transceiver in response to the power level of the one or more transmit signals being above the threshold level, wherein the antenna port is operably connected to the first directional coupler through a third directional coupler; and receiving the receive signal from the first antenna in response to the power level of the one or more transmit signals being above the threshold level.

Embodiment 12. A user element includes a system, wherein the system includes: a first transceiver; a first directional coupler operably connected to the first transceiver; a first antenna operably connected to the first directional coupler; a second directional coupler; a second antenna operably connected to the second directional coupler; a second transceiver operably connected to the second directional coupler; a third transceiver having an antenna port; and a third directional coupler operably connected to the antenna port of the third transceiver, the first directional coupler, and the second directional coupler, wherein the first directional coupler, the second directional coupler, and the third directional coupler are configured to reduce interference that is incurred between the antenna port of the third transceiver and the first transceiver and the second transceiver.

Embodiment 13. The user element of embodiment 12, wherein the system further includes: a first tunable load operably connected to the first directional coupler, wherein the first directional coupler, the second directional coupler, and the third directional coupler being configured to reduce the interference includes the first tunable load being tunable to reduce the interference between the first transceiver and the antenna port; and a second tunable load operably connected to the second directional coupler, wherein the first directional coupler, the second directional coupler, and the third directional coupler being configured to reduce the interference includes the second tunable load being tunable to reduce the interference between the second transceiver and the antenna port.

Embodiment 14. The user element of embodiment 13, wherein the system further includes a termination load, wherein the first directional coupler, the second directional coupler, and the third directional coupler being configured to reduce the interference includes the termination load being coupled to the third directional coupler.

Embodiment 15. The user element of embodiment 14, wherein: the first directional coupler has a first line and a second line; the first line is electromagnetically coupled to the second line; a first port is at a first end of the first line; a second port is at a second end of the first line; a third port is at a third end of the second line; a fourth port is at a fourth end of the second line; the first transceiver is coupled to the first port; the first antenna is coupled to the second port; the first tunable load is coupled to the third port; and the fourth port is coupled to the third directional coupler.

Embodiment 16. The user element of embodiment 15, wherein: the second directional coupler has a third line and a fourth line; the third line is electromagnetically coupled to the fourth line; a fifth port is at a fifth end of the third line; a sixth port is at a sixth end of the third line; a seventh port is at a seventh end of the fourth line; an eighth port is at an eighth end of the fourth line; the second transceiver is coupled to the fifth port; the second antenna is coupled to the sixth port; the second tunable load is coupled to the seventh port; and the eighth port is coupled to the third directional coupler.

Embodiment 17. The user element of embodiment 16, wherein the termination load is a first termination load and wherein the system further includes a second termination load, wherein: the third directional coupler has a fifth line and a sixth line; the fifth line is electromagnetically coupled to the sixth line; a ninth port is at a ninth end of the fifth line; a tenth port is at an tenth end of the fifth line; an eleventh port is at a eleventh end of the sixth line; a twelfth port is at a twelfth end of the sixth line; the ninth port is operably connected to the eighth port; the tenth port is coupled to the second termination load; the eleventh port is operably connected to the antenna port; and the twelfth port is connected to the fourth port.

Embodiment 18. The user element of embodiment 14, wherein the system further comprises: a fourth transceiver; a fourth directional coupler operably connected to the fourth transceiver; a fourth antenna operably connected to the fourth directional coupler; and a fifth directional coupler, wherein the first directional coupler; and the fourth directional coupler are coupled to the third directional coupler through the fifth directional coupler.

Embodiment 19. The user element of embodiment 12, further includes: a first tunable load operably connected to the first directional coupler, wherein the first directional coupler, the second directional coupler, and the third directional coupler being configured to reduce the interference includes the first tunable load being tunable to reduce the interference between the first transceiver and the antenna port; a second tunable load; and an isolator, wherein the second tunable load is operably connected to the third directional coupler and the isolator is connected between the second directional coupler and the third directional coupler, wherein the first directional coupler, the second directional coupler, and the third directional coupler being configured to reduce the interference includes the second tunable load being tunable to reduce the interference between the second transceiver and the antenna port and the isolator being configured to reduce reflections between the second directional coupler and the third directional coupler.

Embodiment 20. The user element of embodiment 1, wherein the system further includes: a first tunable load operably connected to the first directional coupler, wherein the first directional coupler, the second directional coupler, and the third directional coupler being configured to reduce the interference includes the first tunable load being tunable to reduce the interference between the first transceiver and the antenna port; and an adjustment impedance, wherein the adjustment impedance is operably connected between the second directional coupler and the third directional coupler, wherein the first directional coupler, the second directional coupler, and the third directional coupler being configured to reduce the interference includes the adjustment impedance being tunable to reduce the interference between the second transceiver and the antenna port by adjusting a phase and magnitude of an impedance of the adjustment impedance.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a directional coupler, in accordance with some embodiments;

FIG. 2 illustrates a device that includes three transceivers, in accordance with some embodiments;

FIG. 3 illustrates receive signals along different Internet of Things (IoT) channels along a frequency spectrum in addition to a section of the frequency spectrum where transmit signals of Wi-Fi channels interfere with the receive signals at particular IoT channels of the receive signals, in accordance with some embodiments;

FIG. 4A is a graph illustrating Rx sensitivity of an IoT transceiver, such as the third transceiver shown in FIG. 2, in an IoT channel versus interference power of Wi-Fi transmit signals in the Wi-Fi channel shown in FIG. 3, in accordance with some embodiments;

FIG. 4B is a graph illustrating Rx sensitivity of an IoT transceiver, such as the third transceiver shown in FIG. 2, in another IoT channel versus interference power of Wi-Fi transmit signals in the Wi-Fi channel shown in FIG. 3, in accordance with some embodiments;

FIG. 5 illustrates an S-parameter, compensated by a 10.5 dB coupling loss of a directional coupler, between an antenna port of an IoT transceiver and an antenna port of a Wi-Fi transceiver, in accordance with some embodiments;

FIG. 6 illustrates another S-parameter, compensated by a 10.5 dB coupling loss of a directional coupler, between an antenna port of an IoT transceiver and an antenna port of a Wi-Fi transceiver, in accordance with some embodiments;

FIG. 7 illustrates a device that includes four transceivers, in accordance with some embodiments;

FIG. 8 illustrates another device that includes four transceivers, in accordance with some embodiments;

FIG. 9 illustrates yet another device that includes four transceivers, in accordance with some embodiments;

FIG. 10 is a flow diagram illustrating a method of selecting an antenna of a victim transceiver in response to a power level of an aggressor transceiver, in accordance with some embodiments; and

FIG. 11 illustrates a user element, in accordance with some embodiments.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term "and/or" includes any and all combinations of one or more of the associated listed items.

It should also be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present.

It should be understood that, although the terms “upper,” “lower,” “bottom,” “intermediate,” “middle,” “top,” and the like may be used herein to describe various elements, these elements should not be limited by these terms. These terms are only used to distinguish one element from another. For example, a first element could be termed an “upper” element and, similarly, a second element could be termed an “upper” element depending on the relative orientations of these elements, without departing from the scope of the present disclosure.

The terminology used herein is for the purpose of describing particular embodiments only and is not intended to be limiting of the disclosure. As used herein, the singular forms "a," "an," and "the" are intended to include the plural forms as well, unless the context clearly indicates otherwise. It will be further understood that the terms "comprises," "comprising," "includes," and/or "including" when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having meanings that are consistent with their meanings in the context of this specification and the relevant art and will not be interpreted in an idealized or overly formal sense unless expressly so defined herein.

Prior to discussing the main concepts regarding this disclosure, a discussion of a directional coupler is described herein.

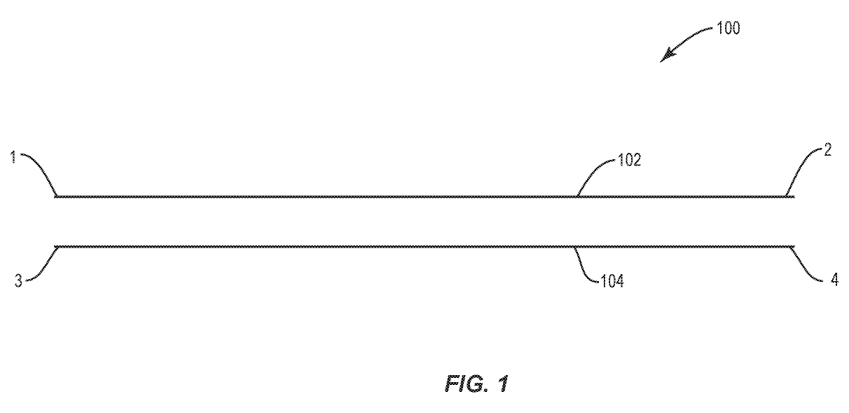

FIG. 1 illustrates the directional coupler 100, in accordance with some embodiments.

The directional coupler 100 includes a pair of transmission lines 102, 104. A port 1 is connected at an end of the transmission line 102 and a port 2 is connected at an oppositely disposed end of the transmission line 102. Thus, port 1 and port 2 share the same transmission line 102. A port 3 is connected at an end of the transmission line 104 and a port 4 is connected at an oppositely disposed end of the transmission line 104. Thus, port 3 and port 4 share the same transmission line 104. Throughout this disclosure, any directional coupler (like the directional coupler 100) will be labeled as having a port 1, a port 2, a port 3, and a port 4, wherein port 1 and port 2 share one line (e.g., the transmission line 102) and port 3 and port 4 share another line (e.g., the transmission line 104).

The transmission lines 102, 104 are electromagnetically coupled by being in close proximity and interacting through their electromagnetic fields due to mutual inductance and capacitance. In some embodiments, capacitive coupling is often the dominant form of coupling, where the lines behave as if connected by a capacitor. The strength of coupling is heavily influenced by physical proximity, with closer lines experiencing stronger coupling. Different geometries can be employed to create the coupled transmission lines 102, 104, including coupled stripline (e.g., planar or edge-coupled and stacked or broadside-coupled) and coupled microstrips. In the transmission lines 102, 104 with geometric symmetry, two modes of excitation can occur: even mode, where currents in the conductors are equal in magnitude and flow in the same direction, and odd mode, where currents are equal but flow in opposite directions. Coupling can be categorized as homogeneous (e.g., triplate) or inhomogeneous (e.g., microstrip), with the latter having different effective permittivities for even and odd modes, resulting in different propagation velocities. The strength of coupling is typically characterized by parameters such as a coupling coefficient, mutual inductance, and mutual capacitance.

Generally, the transmission lines 102, 104 are considered to have a signal port, a through port, a coupled port, and an isolation port. However, which of the ports 1-4 is considered the signal port, the through port, the coupled port, or the isolation port depends on what is coupled to each port. For example, if a signal is input or output from external circuitry at port 1, port 1 may be considered the signal port while port 2 is considered the through port. If port 1 is considered the signal port, then the coupled port is the port on the other transmission line that has a higher signal transmission from the signal port than the other port on the other transmission line, which is accordingly named as isolation port. Which port is the signal, through, coupled, or isolation port in a directional coupler is commonly understood in the art. In this disclosure, if port 1 is viewed as signal port, then port 2 is thru port, port 3 is coupled port, and port 4 isolation port.

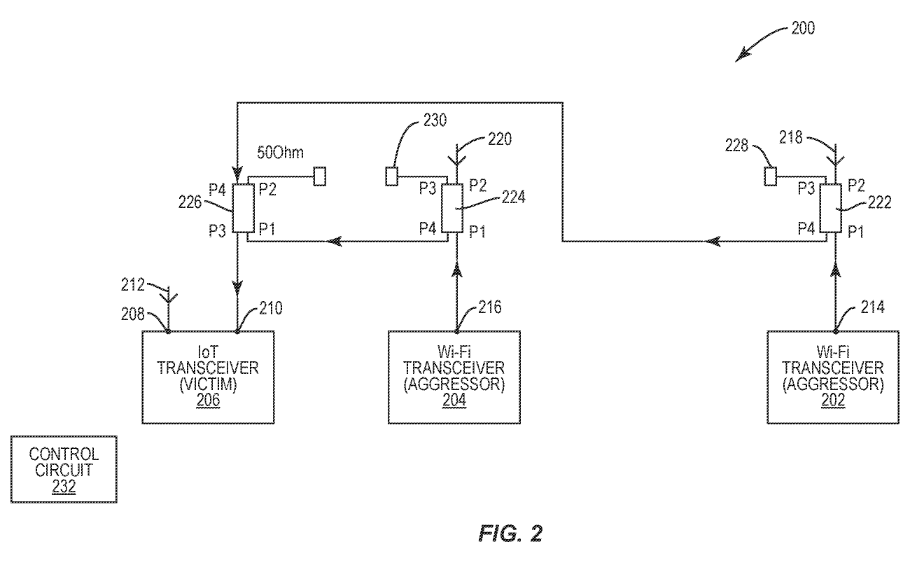

FIG. 2 illustrates a device 200 that includes three transceivers: a first transceiver 202, a second transceiver 204, and a third transceiver 206, in accordance with some embodiments.

In the example device 200, the first transceiver 202 and the second transceiver 204 may operate together as a multiple-input and multiple-output (MIMO) transceiver. In the alternative, the first transceiver 202 may be an independent Wi-Fi transceiver. Additionally, the second transceiver 204 may also be another independent Wi-Fi transceiver. However, the third transceiver 206 may be an Internet of Things (IoT) transceiver. As will explained in further detail below, the first transceiver 202 and the second transceiver 204 are considered to be aggressor transceivers while the third transceiver 206 is considered to be a victim transceiver. It should be noted that, while in the specific example discussed herein, the first and second transceivers 202, 204 are Wi-Fi transceivers and the third transceiver 206 is an IoT transceiver, in other embodiments, the aggressor transceivers and the victim transceiver may be any other type of transceiver. The specific example discussed herein wherein the first and second transceivers 202, 204 are Wi-Fi transceivers and the third transceiver 206 is an IoT transceiver is discussed because the examples herein are particularly advantageous in solving problems presented in this situation. However, the example is not limiting. Other example wireless technologies include, but are not limited to, WI-FI, BLUETOOTH, near-field communication (NFC), ZIGBEE®, local area network (LAN), and wireless local area network (WLAN).

Shown in FIG. 2, the third transceiver 206 has an antenna port 208 and an antenna port 210. An antenna 212 is operably connected to the antenna port 208. The first transceiver 202 has an antenna port 214 and the second transceiver 204 has an antenna port 216. The antenna port 214 is operably connected to an antenna 218 while the antenna port 216 is operably connected to an antenna 220, as will explained in further detail below. In some situations, the first transceiver 202 and/or the second transceiver 204 are operable to transmit one or more transmit signals from the antenna 218 and the antenna 220. The third transceiver 206 is configured to receive receive signals at the antenna 212. In another instance, both the first transceiver 202 and the second transceiver 204 receive the receive signals.

The first, second, and third transceivers 202, 204, 206 are proximate to one another, also known as co-located. In one non-limiting nonexclusive embodiment, the first, second, and third transceivers 202, 204, 206 are separated from one another with a distance equal to or less than two centimeters. In some applications, the distance may be greater than 2 centimeters, which may depend on industrial design and a shape of the box (i.e., housing) that includes the first, second, and third transceivers 202, 204, 206. Because the antenna 212 of the third transceiver 206 receives a receive signal in a frequency band at or close to the frequency band of the transmit signal(s) transmitted from the antennas 218, 220 (and when there isn’t any coordination between the third transceiver 206 and the first and second transceivers 202, 204) the higher power transmit signal(s) from one or more of the antennas 218, 220 can drastically deteriorate the receive sensitivity of the third transceiver 206. Although the third transceiver 206 is capable of detecting the presence of a Wi-Fi channel, it cannot reduce its impacts, and that reduces the receive sensitivity or simply renders the third transceiver 206 inoperable.

In order to solve this problem, the third transceiver 206 is configured to switch from operating with the antenna port 208 to operating with the antenna port 210. In this case, the third transceiver 206 is configured to receive the receive signals at the antenna 218 in response to the transmit power of the transmit signals being above a threshold, as will explained in further detail below. As shown, the device 200 includes a directional coupler 222, a directional coupler 224, and a directional coupler 226. The directional coupler 222 is provided in the same manner as the directional coupler 100, shown in FIG. 1. The directional coupler 224 is provided in the same manner as the directional coupler 100, shown in FIG. 1. The directional coupler 226 is provided in the same manner as the directional coupler 100, shown in FIG. 1.

In an alternative embodiment, the third transceiver 206 may compare the receive signals to interference ratios (instead of measuring the power of the receive signals) at the antenna port 208 and the antenna port 210 and switch between the antenna ports 208, 210 accordingly. In a simple scenario, the first transceiver 202 and the second transceiver 204 set a General Purpose Input/Output (GPIO) voltage to be high in response to the first transceiver 202 and/or the second transceiver 204 transmitting the transmit signals from the antennas 218, 220 and, otherwise the first transceiver 202 and the second transceiver 204 set the GPIO voltage to be low. In response to the GPIO voltage being high, the third transceiver 206 switches from the antenna port 208 to the antenna port 210 to receive the receive signals.

With respect to the directional coupler 222, the antenna port 214 is operably connected to port 1 of the directional coupler 222. The antenna 218 is operably connected to port 2 of the directional coupler 222. A tunable load 228 is operably connected to port 3 of the directional coupler 222. Port 4 of the directional coupler 222 is operably connected to port 4 of the directional coupler 226.

With respect to the directional coupler 224, the antenna port 216 is operably connected to port 1 of the directional coupler 224. Port 2 of the directional coupler 224 is connected to the antenna 220. A tunable load 230 is operably connected to port 3 of the directional coupler 224. Port 4 of the directional coupler 224 is operably connected to port 1 of the directional coupler 226.

With respect to the directional coupler 226, port 1 of the directional coupler 226 is operably connected to port 4 of the directional coupler 224. Port 2 of the directional coupler 226 is operably connected to a 50 Ohm load. Port 4 of the directional coupler 226 is operably connected to port 4 of the directional coupler 222. Port 3 of the directional coupler 226 is connected to the antenna port 210 of the third transceiver 206.

The directional coupler 222, the directional coupler 224, and the directional coupler 226 are configured to reduce interference that is incurred between the antenna port 210 of the third transceiver 206 and the first and second transceivers 202 and 204. As such, the directional coupler 222, the directional coupler 224, and the directional coupler 226 are configured to reduce interference that is incurred between the antenna port 210 of the third transceiver 206 and the antennas 218, 220. More specifically, the directional couplers 222, 224 are inserted in series with the antennas 218, 220 and the coupled port of the directional couplers 222, 224 (i.e., in this case, port 3 of the directional coupler 222 and port 3 of the directional coupler 224) can be tuned with the tunable loads 228, 230 in order to create an out-of-phase copy of the transmit interference(s) (as seen from the third transceiver 206 (i.e., the IoT transceiver) point of view) generated by the transceivers 202 and 204 (i.e., the WiFi transceivers). This out-of-phase version of the transmit interference(s) will cancel or at least reduce the interference that appears at the antenna port 210. In some embodiments, the tunable load 228 is provided as a resistor-inductor-capacitor (RLC) network. In some embodiments, the tunable load 230 is provided as the RLC network. In this manner, the tunable load 228 is tunable to reduce interference between the antenna port 214 and the antenna port 210. Furthermore, the tunable load 230 is tunable to reduce interference between the antenna port 216 and the antenna port 210.

In this embodiment, in response to the third transceiver 206 switching from receiving a receive signal from the antenna port 208 to the antenna port 210, the third transceiver 206 is configured to receive the receive signal from the antenna 218. In some embodiments, insertion losses are introduced by the directional coupler 222 since the receive signal is transmitted from the line (See FIG. 1) between port 1 and port 2 of directional coupler 222 to the other line of the directional coupler 222, where the receive signal is output of port 4 of the directional coupler 222. The receive signal is then transmitted to port 4 of the directional coupler 226. The receive signal thus experiences insertion losses of around 10 dB in the directional coupler 222, in some embodiments. Note, however, that the receive signal is transmitted from port 4 to port 3 in the directional coupler 226 and, thus, is transmitted along the same line to the antenna port 210. Since the receive signal is not transmitted to a coupled port in the directional coupler 226 and is instead transmitted along the same line from port 3 to port 4, much smaller insertion losses are experienced (insertion losses of around .5 dB) in the directional coupler 226.

In some embodiments, a control circuit 232 is provided to switch the third transceiver 206 between the antenna port 208 and the antenna port 210. Furthermore, the control circuit 232 is configured to tune the tunable load 228 and the tunable load 230. In some embodiments, the control circuit 232 is external to the first transceiver 202, the second transceiver 204, and the third transceiver 206. In some embodiments, the control circuit 232 is entirely internal to one of the transceivers 202, 204, 206. In some embodiments, the control circuit 232 is entirely internal to more than one of the transceivers 202, 204, 206. In some embodiments, the control circuit 232 is partially internal to one or more of the transceivers 202, 204, 206 and is partially external to the first transceiver 202, the second transceiver 204, and the third transceiver 206. In some embodiments, the control circuit 232 is provided entirely in analog hardware. In other embodiments, the control circuit 232 is at least partially digital. In some embodiments, the control circuit 232 includes a non-transitory computer readable medium and at least one processor. The non-transitory computer readable medium includes instructions that, when executed by the at least one processor, cause the processor to switch the third transceiver 206 between the antenna port 208 and the antenna port 210 and to tune the tunable loads 228, 230.

In 50 Ohm operation, the coupled port (i.e., the port that connects to the tunable loads 228, 230 is port 3 for the directional coupler 224 and port 3 for the directional coupler 222) is a 50 Ohm resistor and, as such, there isn’t any energy reflected back into the directional couplers 222, 224. When the 50 Ohm resistor is replaced with an RLC network (i.e., the tunable loads 228, 230), the RLC values are adjusted to control the magnitude and phase of a reflected signal. In some cases, one or more of the tunable loads 228, 230 may be as simple as a resistor capacitor, RC, a resistor inductor, RL, or an inductor capacitor, LC, network (this depends on the coupling between the antennas 212, 220, 218). When the tunable load 228 is tuned away from 50 Ohms, the tunable load 228 reflects a portion of the interference generated by the first transceiver 202 that is coupled from port 1 to port 3 of the directional coupler 222. Most of this reflected interference shows up at port 4 of the directional coupler 222 and superimposes on the original interference of the first transceiver 202. This original interference comes from two major paths: one is directly from port 1 to port 4 of the directional coupler 222; the other is first from port 1 to port 2 of the directional coupler 222, which is then partially reflected by the antenna 218 to port 2 of the directional coupler 222 again, and finally from port 2 to port 4 of the directional coupler 222. The magnitude and phase of the reflected interference by the tunable load 228 is determined by the amount of deviation of the tunable load 228 from 50 Ohms. Therefore, the tunable load 228 is configured to generate this reflected interference as an out-of-phase copy of the original interference so that the out-of-phase copy of the interference cancel the original interference.

With respect to the tunable load 230, the cancellation operation is different. Like the interference by the first transceiver 202, a portion of the interference from the second transceiver 204 shows at port 4 of the directional coupler 224. However, this portion of interference is coupled from port 1 to port 3 of the directional coupler 226 before this portion of the interference shows up at the antenna port 210. This interference is -usually an order of magnitude lower than another portion of the same interference generated by the second transceiver 204 that goes through the path from port 1 of the directional coupler 224 to port 2 of the directional coupler 224 to the antenna 220, to the antenna 218, to port 2 of the directional coupler 222, to port 4 of the directional coupler 222, to port 4 of the directional coupler 226, to port 3 of the directional coupler 226, and finally to the antenna port 210. In this context, this portion of the interference is the dominant interference by the second transceiver 204 seen at the antenna port 210. The tunable load 230 is deviated away from 50 Ohms to cancel this portion of interference from the second transceiver 204. The portion of interference reflected from the tunable load 230 passes through port 3 and port 4 of the directional coupler 224, port 1 of the directional coupler 226, and superimposes the dominant interference of the second transceiver 204 at port 3 of the directional coupler 226, which cancels the interference, or at least reduces it. One may notice that, for the interference of the first transceiver 202, there is also a portion of the interference that passes port 1 and port 2 of the directional coupler 222, the antenna 218, the antenna 220, port 2 and port 4 of the directional coupler 224, and port 1 and port 3 of the directional coupler 226 to the antenna port 210. This portion of the interference of the first transceiver 202 is usually an order of magnitude lower than the interference of the first transceiver 202 that shows up at port 4 of the directional coupler 222, if not cancelled. In some embodiments, the non-dominant interference of the first and second transceivers 202, 204 are ignored, with the understanding that, if we choose so, they can also be cancelled by finer tuning of the tunable loads 228, 230.

The device 200 thereby allows for a victim transceiver (e.g., the third transceiver 206) to be co-located with various aggressor transceivers (e.g., the first and second transceivers 202, 204). By tuning the tunable loads 228, 230, the interference resulting from the transmit signals of the aggressor transceivers are cancelled, or are at least reduced at the antenna port (e.g., the antenna port 210) that is being used by the victim transceiver (e.g., the third transceiver 206). This allows the victim transceiver (e.g., the third transceiver 206) to use one of the antennas (e.g., the antenna 218) that is being utilized by the aggressor transceivers (e.g., the first and second transceivers 202, 204) while having reduced interference by the aggressor transceivers (e.g., the first and second transceivers 202, 204). Multiple aggressor transceivers with multiple antennas can be co-located with the victim transceiver but still be operational even when there is no coordination between the victim transceiver and the aggressor transceivers.

It should be noted that, in some embodiments, the tunable loads 228, 230 are not utilized but, instead, each of these components may be fixed loads. In this case, the impedances of the fixed loads are predetermined in a design state to appropriately cancel or at least reduce the interferences discussed above.

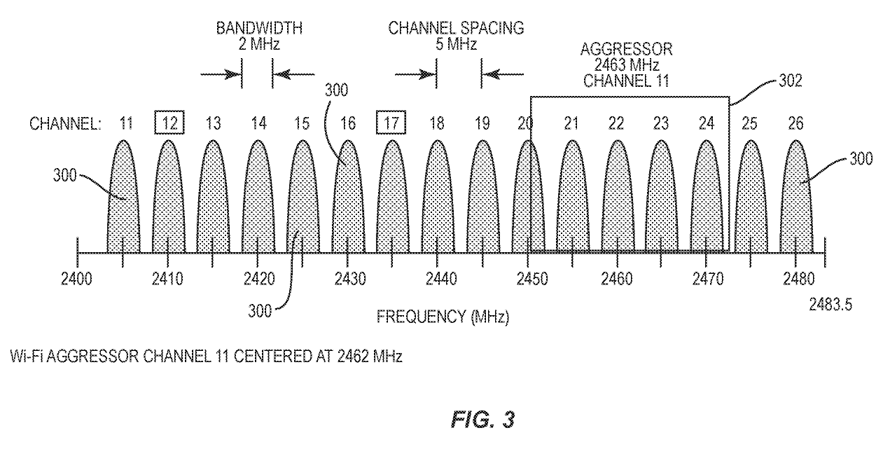

FIG. 3 illustrates receive signals 300 (not all labeled for the sake of clarity) along different IoT channels along a frequency spectrum in addition to a section 302 of the frequency spectrum where transmit signals of Wi-Fi channels interfere with the receive signals 300 at particular IoT channels of the receive signals 300, in accordance with some embodiments.

When the receive signals 300 of an IoT transceiver (e.g., see the third transceiver 206 in FIG. 2) and the transmit signals of one or more Wi-Fi transceivers (e.g., see the first and second transceivers 202, 204 in FIG. 2) operate in the same frequency band without coordination, the more powerful transmit signals transmitted by the Wi-Fi transceivers can significantly impair the receive (Rx) sensitivity of the IoT transceivers. The receive signals 300 in each IoT channel has a bandwidth of 2 MHz and a channel spacing of 5 MHz. Although the IoT transceiver can detect the transmit power of the transmit signals in Wi-Fi channels, the IoT transceiver cannot mitigate their effects, resulting in reduced Rx sensitivity or even completely rendering the IoT transceiver inoperable to detect the receive signals 300.

Consider the scenario shown in FIG. 3. In FIG. 3, an antenna being utilized by the Wi-Fi transceiver is near an antenna being utilized by the IoT transceiver. This scenario is common when the antenna being utilized by the Wi-Fi transceiver and the antenna being utilized by the IoT transceiver are in the same user element. Shown in FIG. 2, the third transceiver 206 has the two antenna ports 208, 210 and is configured to switch between the two antenna ports 208, 210 in order to utilize either the antenna 212 or the antenna 218. FIG. 3 illustrates an overlay of the IoT channels and the transmit signal in the section 302 that causes interference with the receive signals 300. For example, the Rx sensitivity of the receive signals 300 was evaluated while increasing the power of the transmit signal on a Wi-Fi channel 11 in the section 302 of the frequency spectrum (centered at 2462 MHz).

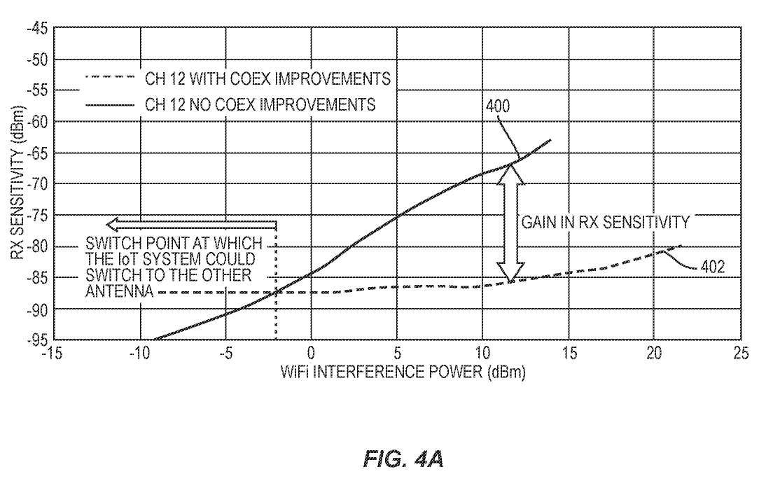

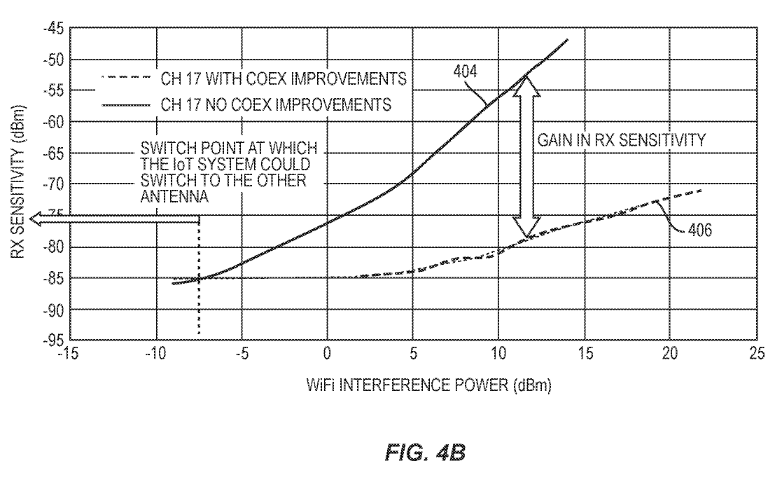

FIG. 4A is a graph illustrating Rx sensitivity of an IoT transceiver, such as the third transceiver 206 shown in FIG. 2, in an IoT channel 12 versus interference power of Wi-Fi transmit signals in the Wi-Fi channel 11 shown in FIG. 3, in accordance with some embodiments.

A first trace 400 is the Rx sensitivity of a device without the improvements disclosed herein. A second trace 402 is the Rx sensitivity of the third transceiver 206 shown in FIG. 2 when switching to the antenna port 210 shown in FIG. 2 and utilizing the antenna 218 shown in FIG. 2.

Shown in FIG. 4A, the first trace 400 and the second trace 402 intersect at -2dBm. Thus, when the Wi-Fi interference power is below the threshold -2 dBm, the trace 400 actually shows better performance. However, when the Wi-Fi interference power is above the -2 dBm threshold, the second trace 402 actually shows better performance. Thus, in some embodiments, the third transceiver 206 is configured to detect the Wi-Fi interference power. For receiving the receive signal in the IoT channel 12, the third transceiver 206 is configured to switch to the antenna port 208 shown in FIG. 2 and utilize the antenna 212 shown in FIG. 2 to receive the receive signal in the IoT channel 12 in response to the Wi-Fi interference power being below the -2 dBm threshold. However, in response to the Wi-Fi interference power being above or equal to the -2 dBm threshold, the third transceiver 206 is configured to switch to the antenna port 210 and utilize the antenna 218 to receive the receive signal in the IoT channel 12. Note that the second trace 402 shows far less impact from the Wi-Fi interferer. There is an improvement in Rx sensitivity of 20 dB or more when the Wi-Fi interference power is above 13 to 15 dBm.

In some embodiments, the threshold is different for different receive signals along different IoT channels. For example, for an IoT channel 17, the switch point may be around -7 dBm. This will depend on the intersection of the traces 400, 402, as plotted for each individual channel.

FIG. 4B is a graph illustrating Rx sensitivity of an IoT transceiver, such as the third transceiver 206 shown in FIG. 2, in the IoT channel 17 versus interference power of Wi-Fi transmit signals in the Wi-Fi channel 11 shown in FIG. 3, in accordance with some embodiments.

A first trace 404 is the Rx sensitivity of a device without the improvements disclosed herein. A second trace 406 is the Rx sensitivity of the third transceiver 206 shown in FIG. 2 when switching to the antenna port 210 shown in FIG. 2 and utilizing the antenna 218 shown in FIG. 2.

Shown in FIG. 4B, the first trace 404 and the second trace 406 intersect at -7 dBm. Thus, when the Wi-Fi interference power is below the threshold of -7 dBm, the first trace 404 actually shows better performance. However, when the Wi-Fi interference power is above the -7dBm threshold, the second trace 406 actually shows better performance. Thus, in some embodiments, the third transceiver 206 is configured to detect the Wi-Fi interference power. For receiving the receive signal in the IoT channel 17, the third transceiver 206 is configured to switch to the antenna port 208 shown in FIG. 2 and utilize the antenna 212 shown in FIG. 2 to receive the receive signal in the IoT channel 17 in response to the Wi-Fi interference power being below the -7 dBm threshold. However, in response to the Wi-Fi interference power being above or equal to the -7 dBm threshold, the third transceiver 206 is configured to switch to the antenna port 210 and utilize the antenna 218 to receive the receive signal in the IoT channel 17. Note that the second trace 406 shows far less impact from the Wi-Fi interferer.

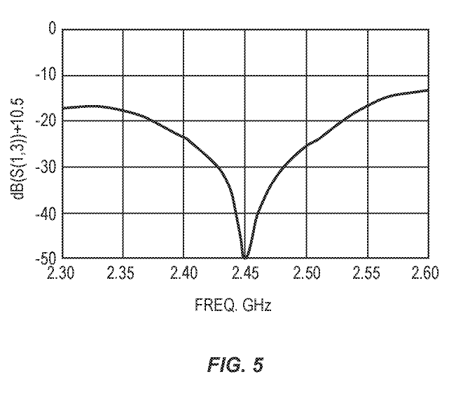

FIG. 5 illustrates an S-parameter, compensated by a 10.5 dB coupling loss of the directional coupler 224, between the antenna port 210 of an IoT transceiver (such as the third transceiver 206 in FIG. 2) and the antenna port 216 of a Wi-Fi transceiver (such as the second transceiver 204 in FIG. 2), in accordance with some embodiments.

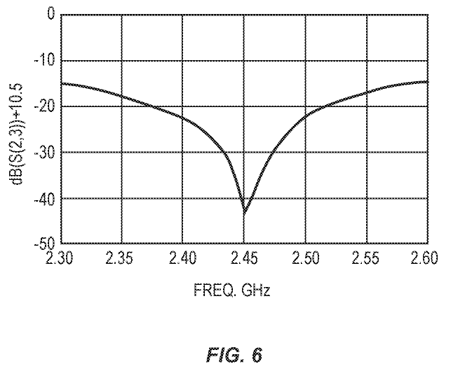

FIG. 6 illustrates another S-parameter, compensated by a 10.5 dB coupling loss of the directional coupler 222, between the antenna port 210 of an IoT transceiver (such as the third transceiver 206 in FIG. 2) and the antenna port 214 of a Wi-Fi transceiver (such as the first transceiver 202 in FIG. 2), in accordance with some embodiments.

In both FIG. 5 and FIG. 6, the interfering signal is assumed to be centered at 2.45 GHz.

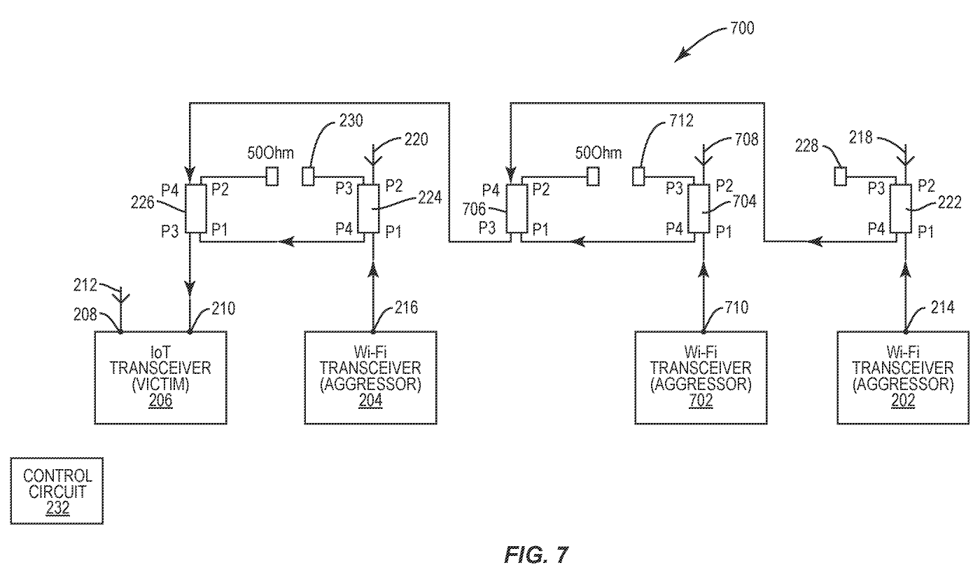

FIG. 7 illustrates a device 700 that includes four transceivers: the first transceiver 202, the second transceiver 204, the third transceiver 206, and a fourth transceiver 702, in accordance with some embodiments.

The device 700 is similar to the device 200 shown in FIG. 2, except that the device 700 further includes the fourth transceiver 702, a directional coupler 704, a directional coupler 706, and an antenna 708. In FIG. 7, the fourth transceiver 702 is another aggressor transceiver that transmits transmit signals from the antenna 708. To add the additional antenna 708 and the fourth transceiver 702, the device 700 includes the directional coupler 704 and the directional coupler 706. The directional coupler 704 is provided in the same manner as the directional coupler 100 shown in FIG. 1. The directional coupler 706 is also provided in the same manner as the directional coupler 100.

With respect to the directional coupler 704, port 1 of the directional coupler 704 is operably connected to an antenna port 710 of the fourth transceiver 702. Port 2 of the directional coupler 704 is operably connected to the antenna 708. Port 3 of the directional coupler 704 is operably connected to a tunable load 712. Port 4 of the directional coupler 704 is operably connected to port 1 of the directional coupler 706.

With respect to the directional coupler 706, port 1 of the directional coupler 706 is operably connected to port 4 of the directional coupler 704. Port 2 of the directional coupler 706 is operably connected to a 50Ohm load. Port 3 of the directional coupler 706 is operably connected to port 4 of the directional coupler 226. Port 4 of the directional coupler 706 is operably connected to port 4 of the directional coupler 222.

The directional coupler 222, the directional coupler 224, the directional coupler 226, the directional coupler 704, and the directional coupler 706 are configured to reduce interference that is incurred between the antenna port 210 of the third transceiver 206 and the antenna ports 214, 216, 710 of the first, second, and fourth transceivers 202, 204, 702. More specifically, the directional couplers 222, 224, 704 are inserted in series with the antennas 218, 220, 708 and the coupled port (i.e., in this case, port 3 of the directional coupler 222, port 3 of the directional coupler 224, and port 3 of the directional coupler 704) of the directional couplers 222, 224, 704 can be tuned with the tunable loads 228, 230, 712 in order to create an out-of-phase copy of the transmit interference(s) at port 4 of the directional coupler 222, at port 3 of the directional coupler 226, and at port 3 of the directional coupler 706. At port 4 of the directional coupler 222, the cancelled interference is from the first transceiver 202, at port 3 of the directional coupler 226, the cancelled interference is from the second transceiver 204, and at port 3 of the directional coupler 706, the cancelled interference is from the fourth transceiver 702. This will cancel or at least reduce the interference that appears at the antenna port 210. Just like the tunable loads 228, 230, the tunable load 712 is provided as an RLC network, in accordance with some embodiments. The tunable load 712 works under the same principle as the tunable load 230 shown in FIG. 2.

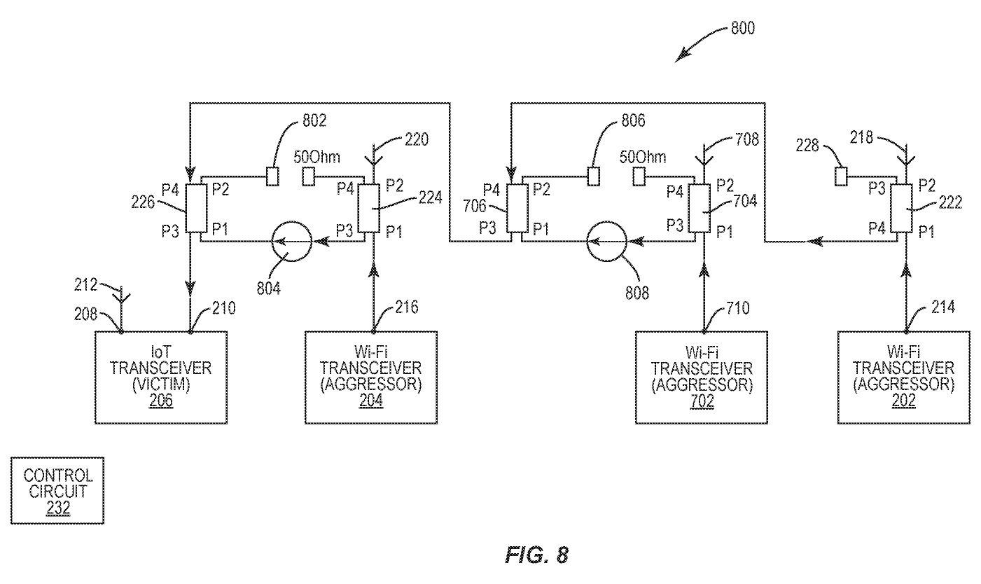

FIG. 8 illustrates another device 800 that includes four transceivers: the first transceiver 202, the second transceiver 204, the third transceiver 206, and the fourth transceiver 702, in accordance with some embodiments.

The device 800 is similar to the device 700 shown in FIG. 7. However, the device 800 does not include the tunable loads 230, 712. However, note that with respect to FIG. 7, port 3 and port 4 are switched for the directional coupler 224 and port 3 and port 4 are switched for the directional coupler 704 in FIG. 8. Also note that a 50 Ohm load is operably connected to port 4 of the directional coupler 704 and a 50 Ohm load is operably connected to port 4 of the directional coupler 224. Furthermore, a tunable load 802 is operably connected to port 2 of the directional coupler 226 instead of a 50 Ohm load. Additionally, an optional isolator 804 is operably connected between port 1 of the directional coupler 226 and port 3 of the directional coupler 224. Also, a tunable load 806 is operably connected to port 2 of the directional coupler 706. Finally, an optional isolator 808 is operably connected between port 1 of the direction coupler 706 and port 3 of the directional coupler 704.

The directional coupler 222, the directional coupler 224, the directional coupler 226, the directional coupler 704, and the directional coupler 706 are configured to reduce interference that is incurred between the antenna port 210 of the third transceiver 206 and the antenna ports 214, 216, 710. More specifically, the directional couplers 222, 224, 704, 706 are inserted in series with the antennas 218, 220, 708 and the coupled port (i.e., in this case port 3 of the directional coupler 222, port 2 of the directional coupler 706, and port 2 of the directional coupler 226) of the directional couplers 222, 226, 706 can be tuned with the tunable loads 228, 802, 806 in order to create an out-of-phase copy of the interference(s) at port of the directional coupler 222 (i.e., interference of the first transceiver 202), at port 3 of the directional coupler 226 (i.e., interference of the second transceiver 204), and at port 3 of the directional coupler 706 (i.e., interference at the antenna port 710 of the fourth transceiver 702). This out-of-phase version of the interference(s) will cancel or at least reduce the interference that appears at the antenna port 210. In some embodiments, the tunable load 802 is an RLC network. In some embodiments, the tunable load 806 is an RLC network. The tunable load 802 is tunable to reduce interference between the second transceiver 204 and port 3 of the directional coupler 226. Additionally, the tunable load 806 is tunable to reduce interference between the transceiver 702 and port 3 of the directional coupler 706.

The optional isolator 804 prevents loading of the transceiver 204 by the downstream circuits from port 3 of the directional coupler 224. Additionally, the optional isolator 808 is configured to prevent loading of the fourth transceiver 702 by the downstream circuits from port 3 of the directional coupler 704.

An isolator (such as the optional isolator 804 and the optional isolator 808) is a 2-port device, also known as a circulator, which is a 3-port device, with the 3^{rd} port internally terminated. It operates on a gyromagnetic behavior of a ferrite material when exposed to a magnetic field from a magnet. This creates a directionality by which radio frequency (RF) energy flows in one direction with low loss, while much higher insertion loss is incurred when the RF energy flows in the opposite direction as it is directed towards the 3^{rd} port which is terminated into 50 Ohms and, as such, no energy is reflected back.

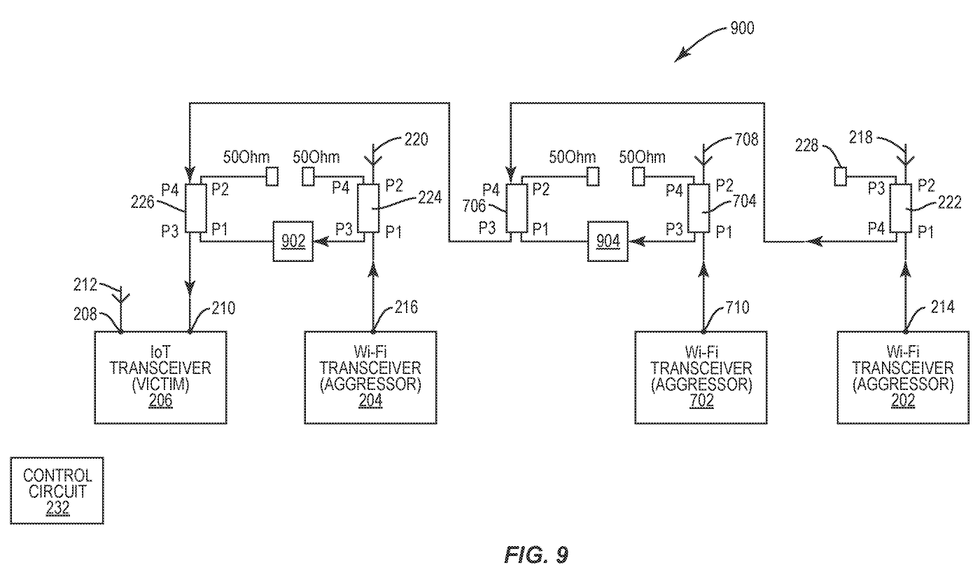

FIG. 9 illustrates yet another device 900 that includes four transceivers: the first transceiver 202, the second transceiver 204, the third transceiver 206, and the fourth transceiver 702, in accordance with some embodiments.

The device 900 is similar to the device 700 shown in FIG. 7. However, the device 900 does not include the tunable loads 230, 712. However, note that with respect to FIG. 7, port 3 and port 4 are switched for the directional coupler 224 and port 3 and port 4 are switched for the directional coupler 704 in FIG. 8. Instead, a 50 Ohm load is operably connected to port 4 of the directional coupler 704 and a 50 Ohm load is operably connected to port 4 of the directional coupler 224. Furthermore, the device 900 includes an adjustment impedance 902 that is operably connected between port 1 of the directional coupler 226 and port 3 of the directional coupler 224. Additionally, an adjustment impedance 904 is connected between port 1 of the directional coupler 706 and port 3 of the directional coupler 704.

The directional coupler 222, the directional coupler 224, the directional coupler 226, the directional coupler 704, and the directional coupler 706 are configured to reduce interference that is incurred between the antenna port 210 of the third transceiver 206 and the antenna ports 214, 216, 710. The adjustment impedance 902 is tunable to reduce interference between the second transceiver 204 and port 3 of the directional coupler 226 by adjusting a phase and magnitude of an impedance of the adjustment impedance 902. The adjustment impedance 902 is configured to pass a portion of the interference transmitted from the second transceiver 204 to port 3 of the directional coupler 226 via the antenna port 216, port 1 of the directional coupler 224, port 3 of the directional coupler 224, the adjustment impedance 902, and port 1 of the directional coupler 226. Similarly, the adjustment impedance 904 is configured to pass a portion of the interference transmitted from the fourth transceiver 702 to port 3 of the directional coupler 706 via the antenna port 710, port 1 of the directional coupler 704, port 3 of the directional coupler 704, the adjustment impedance 904, and port 1 of the directional 706. At port 3 of the directional coupler 226, the interference of the second transceiver 204 is cancelled; and at port 3 of the directional coupler 706, the interference of the fourth transceiver 702 is cancelled.

Please note that the devices 200, 700, 800, 900 in FIG. 2, FIG. 7, FIG. 8, and FIG. 9 are simply exemplary and that other embodiments are within the scope of this disclosure. In particular, note that the concepts described herein can be utilized to N number of victim transceivers and M number of aggressor transceivers in order to reduce the interference of the aggressor transceivers on the victim transceivers. The number N is an integer number greater or equal to 1 and the number M is an integer number greater or equal to 1. For example, one can see by comparing the device 200 in FIG. 2 and the device 700 in FIG. 7 that the device 700 in FIG. 7 is expanded with respect to the device 200 in FIG. 2 by adding the additional fourth transceiver 702, which is another aggressor transceiver. This expansion can be continued in order to add more aggressor transceivers, utilizing the concepts described in this disclosure.

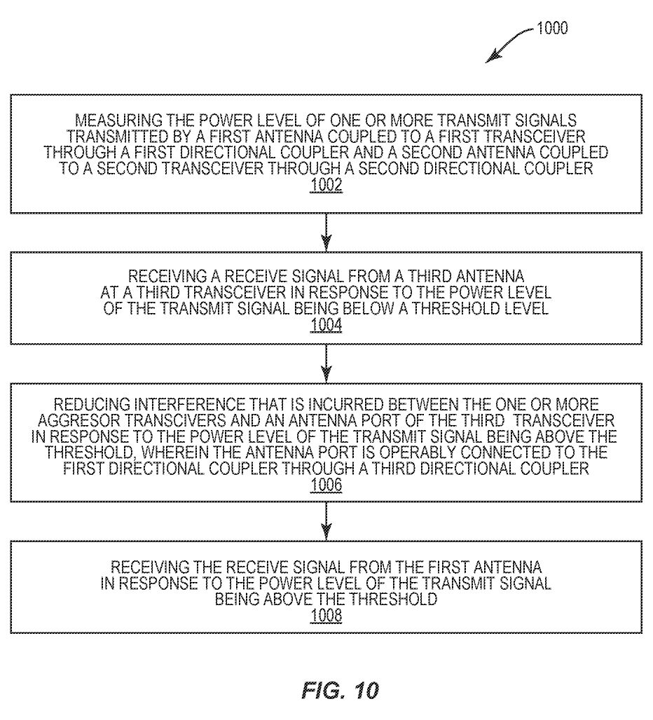

FIG. 10 is a flow diagram 1000 illustrating a method of selecting an antenna of a victim transceiver in response to a power level of an aggressor transceiver, in accordance with some embodiments.

In some embodiments, the method is performed by the device 200 shown in FIG. 2, the device 700 shown in FIG. 7, the device 800 shown in FIG. 8, and the device 900 as in FIG. 9, in accordance with some embodiments. The flow diagram 1000 includes blocks 1002 - 1008. Flow begins at block 1002.

At block 1002, the power level of one or more transmit signals transmitted by a first antenna coupled to a first transceiver through a first directional coupler and a second antenna coupled to a second transceiver through a second directional coupler is measured. An example of the first antenna is the antenna 218 shown in FIG. 2. An example of the first transceiver is the first transceiver 202 shown in FIG. 2. An example of the second antenna is the antenna 220 shown in FIG. 2 and the antenna 708 shown in FIG. 7. An example of the second transceiver is the second transceiver 204 shown in FIG. 2 and the fourth transceiver 702 shown in in FIG. 7. In some embodiments, the first directional coupler is the directional coupler 222 shown in FIG. 2. In some embodiments, the second directional coupler is the directional coupler 224 shown in FIG. 2 and the directional coupler 704 shown in FIG. 7. In some embodiments, block 1002 is performed by the control circuit 232 shown in FIG. 2. Flow then proceeds to block 1004.

At block 1004, a receive signal from a third antenna at a third transceiver is received in response to the power level of the transmit signal being below a threshold level. An example of the third antenna is the antenna 212 shown in FIG. 2. An example of the third transceiver is the third transceiver 206 shown in FIG. 2. In some embodiments, the control circuit 232 shown in FIG. 2 is involved in performing block 1004 by switching to the antenna port 208 shown in FIG. 2 that is operably connected to the antenna 212. In some embodiments, the threshold level is the −2 dBm threshold shown in FIG. 4A and the −7 dBm threshold in FIG. 4B. Flow then proceeds to block 1006.

At block 1006, interference that is incurred between the one or more aggressor transceivers and an antenna port of the third transceiver is reduced in response to the power level of the transmit signal being above the threshold, wherein the antenna port is operably connected to the first directional coupler through a third directional coupler. In some embodiments, the antenna port is the antenna port 210 shown in FIG. 2. In some embodiments, the third directional coupler is the directional coupler 226 shown in FIG. 2. In some embodiments, the interference is reduced when the control circuit 232 shown in FIG. 2 tunes the tunable loads 228, 230 shown in FIG. 2. In some embodiments, the interference is reduced when the control circuit 232 tunes the tunable load 712 shown in FIG. 7. In some embodiments, the interference is reduced when the control circuit 232 tunes the tunable loads 228, 802, 806 shown in FIG. 8. In some embodiments, the interference is reduced when the control circuit 232 tunes the tunable load 228 and the adjustment impedances 902, 904 shown in FIG. 9. Flow then proceeds to block 1008.

At block 1008, the receive signal from the first antenna is received in response to the power level of the transmit signal being above the threshold. In some embodiments, the control circuit 232 shown in FIG. 2 is configured to switch to the antenna port 210 shown in FIG. 2 in response to the power level being above the threshold.

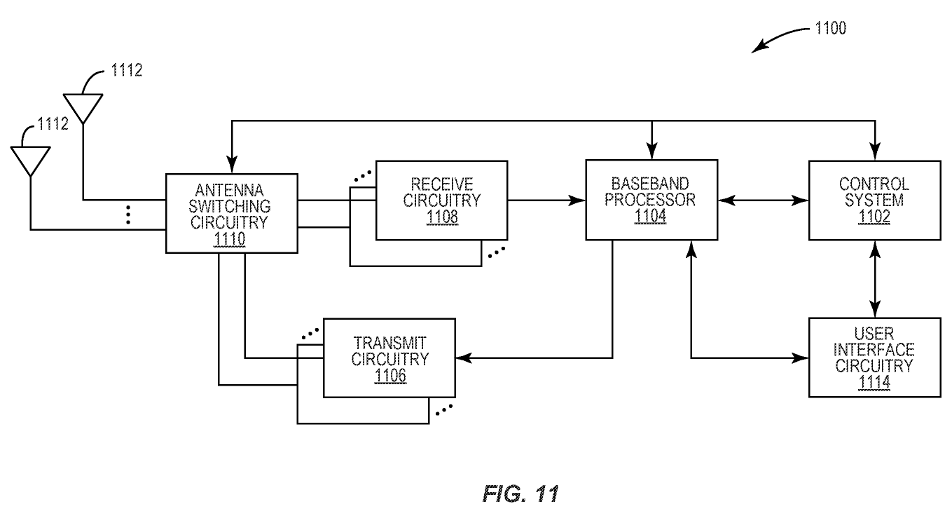

FIG. 11 illustrates a user element, in accordance with some embodiments.

With reference to FIG. 11, the concepts described above may be implemented in various types of user elements 1100, such as mobile terminals, smart watches, tablets, computers, navigation devices, access points, and like wireless communication devices that support wireless communications, such as cellular, wireless local area network (WLAN), Bluetooth, and near field communications. The user element 1100 will generally include a control system 1102, a baseband processor 1104, transmit circuitry 1106, receive circuitry 1108, antenna switching circuitry 1110, multiple antennas 1112, and user interface circuitry 1114. In a non-limiting example, the control system 1102 may be a field-programmable gate array (FPGA) or an application-specific integrated circuit (ASIC). In this regard, the control system 1102 may include at least a microprocessor(s), an embedded memory circuit(s), and a communication bus interface(s). The receive circuitry 1108 receives radio frequency signals via the antennas 1112 and through the antenna switching circuitry 1110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 1104 processes the digitized received signal to extract the information or data bits conveyed in the received signal. This processing typically comprises demodulation, decoding, and error correction operations, as will be discussed in greater detail below. The baseband processor 1104 is generally implemented in one or more digital signal processors (DSPs) and application specific integrated circuits (ASICs).

For transmission, the baseband processor 1104 receives digitized data, which may represent voice, data, or control information, from the control system 1102, which it encodes for transmission. The encoded data is output to the transmit circuitry 1106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 1112 through the antenna switching circuitry 1110. The multiple antennas 1112 and the replicated transmit and receive circuitries 1106, 1108 may provide spatial diversity. Modulation and processing details will be understood by those skilled in the art.

Those skilled in the art will recognize improvements and modifications to the preferred embodiments of the present disclosure. All such improvements and modifications are considered within the scope of the concepts disclosed herein and the claims that follow.

What is claimed is:

1. A system, comprising:
a first transceiver;
a first directional coupler operably connected to the first transceiver;
a first antenna operably connected to the first directional coupler;
a second directional coupler;
a second antenna operably connected to the second directional coupler;
a second transceiver operably connected to the second directional coupler;
a third transceiver having an antenna port; and
a third directional coupler operably connected to the antenna port of the third transceiver, the first directional coupler, and the second directional coupler, wherein the first directional coupler, the second directional coupler, and the third directional coupler are configured to reduce interference that is incurred between the antenna port of the third transceiver and the first transceiver and the second transceiver.

2. The system of claim 1, further comprising:
a first tunable load operably connected to the first directional coupler, wherein the first directional coupler, the second directional coupler, and the third directional coupler being configured to reduce the interference comprise the first tunable load being tunable to reduce the interference between the first transceiver and the antenna port; and
a second tunable load operably connected to the second directional coupler, wherein the first directional coupler, the second directional coupler, and the third directional coupler being configured to reduce the interference comprise the second tunable load being tunable to reduce the interference between the second transceiver and the antenna port.

3. The system of claim 2, further comprising a termination load, wherein the first directional coupler, the second directional coupler, and the third directional coupler being configured to reduce the interference comprise the termination load being coupled to the third directional coupler.

4. The system of claim 3, wherein:
the first directional coupler has a first line and a second line;
the first line is electromagnetically coupled to the second line;
a first port is at a first end of the first line;
a second port is at a second end of the first line;
a third port is at a third end of the second line;
a fourth port is at a fourth end of the second line;
the first transceiver is coupled to the first port;
the first antenna is coupled to the second port;
the first tunable load is coupled to the third port; and
the fourth port is coupled to the third directional coupler.

5. The system of claim 4, wherein:
the second directional coupler has a third line and a fourth line;
the third line is electromagnetically coupled to the fourth line;
a fifth port is at a fifth end of the third line;
a sixth port is at a sixth end of the third line;
a seventh port is at a seventh end of the fourth line;
an eighth port is at an eighth end of the fourth line;
the second transceiver is coupled to the fifth port;
the second antenna is coupled to the sixth port;
the second tunable load is coupled to the seventh port; and
the eighth port is coupled to the third directional coupler.

6. The system of claim 5, wherein the termination load is a first termination load and wherein the system further comprises a second termination load, wherein:
the third directional coupler has a fifth line and a sixth line;
the fifth line is electromagnetically coupled to the sixth line;
a ninth port is at a ninth end of the fifth line;
a tenth port is at an tenth end of the fifth line;
an eleventh port is at a eleventh end of the sixth line;
a twelfth port is at a twelfth end of the sixth line;
the ninth port is operably connected to the eighth port;
the tenth port is coupled to the second termination load;
the eleventh port is operably connected to the antenna port; and
the twelfth port is connected to the fourth port.

7. The system of claim 3, further comprising:
a fourth transceiver;
a fourth directional coupler operably connected to the fourth transceiver;
a fourth antenna operably connected to the fourth directional coupler; and
a fifth directional coupler, wherein the first directional coupler; and
the fourth directional coupler are coupled to the third directional coupler through the fifth directional coupler.

8. The system of claim 1, further comprising:
a first tunable load operably connected to the first directional coupler, wherein the first directional coupler, the second directional coupler, and the third directional coupler being configured to reduce the interference comprise the first tunable load being tunable to reduce the interference between the first transceiver and the antenna port;
a second tunable load; and
an isolator, wherein the second tunable load is operably connected to the third directional coupler and the isolator is connected between the second directional coupler and the third directional coupler, wherein the first directional coupler, the second directional coupler, and the third directional coupler being configured to reduce the interference comprise the second tunable load being tunable to reduce the interference between the second transceiver and the antenna port and the isolator being configured to reduce reflections between the second directional coupler and the third directional coupler.

9. The system of claim 1, further comprising:
a first tunable load operably connected to the first directional coupler, wherein the first directional coupler, the second directional coupler, and the third directional coupler being configured to reduce the interference comprise the first tunable load being tunable to reduce the interference between the first transceiver and the antenna port; and
an adjustment impedance, wherein the adjustment impedance is operably connected between the second directional coupler and the third directional coupler, wherein the first directional coupler, the second directional coupler, and the third directional coupler being configured to reduce the interference comprise the adjustment impedance being tunable to reduce the interference between the second transceiver and the antenna port by adjusting a phase and magnitude of an impedance of the adjustment impedance.

10. The system of claim 1, wherein the antenna port of the third transceiver is a first antenna port, wherein the third transceiver further comprises a second antenna port, and wherein the system the further comprises and a control circuit configured to switch between the third transceiver between the first antenna port and the second antenna port.

11. A method of selecting an antenna of a victim transceiver in response to a power level of one or more aggressor transceivers, the method comprising:
measuring the power level of one or more transmit signals transmitted by a first antenna coupled to a first transceiver through a first directional coupler and a second antenna coupled to a second transceiver through a second directional coupler;
receiving a receive signal from a third antenna at a third transceiver in response to the power level of the one or more transmit signals being below a threshold level;
reducing interference that is incurred between the one or more aggressor transceivers and an antenna port of the third transceiver in response to the power level of the one or more transmit signals being above the threshold level, wherein the antenna port is operably connected to the first directional coupler through a third directional coupler; and
receiving the receive signal from the first antenna in response to the power level of the one or more transmit signals being above the threshold level.

12. A user element comprising a system, wherein the system comprises:
a first transceiver;
a first directional coupler operably connected to the first transceiver;
a first antenna operably connected to the first directional coupler;
a second directional coupler;
a second antenna operably connected to the second directional coupler;
a second transceiver operably connected to the second directional coupler;
a third transceiver having an antenna port; and
a third directional coupler operably connected to the antenna port of the third transceiver, the first directional coupler, and the second directional coupler, wherein the first directional coupler, the second directional coupler, and the third directional coupler are configured to reduce interference that is incurred between the antenna port of the third transceiver and the first transceiver and the second transceiver.

13. The user element of claim 12, wherein the system further comprises:
a first tunable load operably connected to the first directional coupler, wherein the first directional coupler, the second directional coupler, and the third directional coupler being configured to reduce the interference comprise the first tunable load being tunable to reduce the interference between the first transceiver and the antenna port; and
a second tunable load operably connected to the second directional coupler, wherein the first directional coupler, the second directional coupler, and the third directional coupler being configured to reduce the interference comprise the second tunable load being tunable to reduce the interference between the second transceiver and the antenna port.

14. The user element of claim 13, wherein the system further comprises a termination load, wherein the first directional coupler, the second directional coupler, and the third directional coupler being configured to reduce the interference comprise the termination load being coupled to the third directional coupler.

15. The user element of claim 14, wherein:
the first directional coupler has a first line and a second line;
the first line is electromagnetically coupled to the second line;
a first port is at a first end of the first line;
a second port is at a second end of the first line;
a third port is at a third end of the second line;
a fourth port is at a fourth end of the second line;
the first transceiver is coupled to the first port;
the first antenna is coupled to the second port;
the first tunable load is coupled to the third port; and
the fourth port is coupled to the third directional coupler.

16. The user element of claim 15, wherein:
the second directional coupler has a third line and a fourth line;
the third line is electromagnetically coupled to the fourth line;
a fifth port is at a fifth end of the third line;
a sixth port is at a sixth end of the third line;
a seventh port is at a seventh end of the fourth line;
an eighth port is at an eighth end of the fourth line;
the second transceiver is coupled to the fifth port;
the second antenna is coupled to the sixth port;
the second tunable load is coupled to the seventh port; and
the eighth port is coupled to the third directional coupler.

17. The user element of claim 16, wherein the termination load is a first termination load and wherein the system further comprises a second termination load, wherein:
the third directional coupler has a fifth line and a sixth line;
the fifth line is electromagnetically coupled to the sixth line;
a ninth port is at a ninth end of the fifth line;
a tenth port is at a tenth end of the fifth line;
an eleventh port is at an eleventh end of the sixth line;
a twelfth port is at a twelfth end of the sixth line;
the ninth port is operably connected to the eighth port;
the tenth port is coupled to the second termination load;
the eleventh port is operably connected to the antenna port; and
the twelfth port is connected to the fourth port.

18. The user element of claim 14, wherein the system further comprises:
a fourth transceiver;
a fourth directional coupler operably connected to the fourth transceiver;
a fourth antenna operably connected to the fourth directional coupler; and
a fifth directional coupler, wherein the first directional coupler; and
the fourth directional coupler are coupled to the third directional coupler through the fifth directional coupler.

19. The user element of claim 12, further comprising:
a first tunable load operably connected to the first directional coupler, wherein the first directional coupler, the second directional coupler, and the third directional coupler being configured to reduce the interference comprise the first tunable load being tunable to reduce the interference between the first transceiver and the antenna port;
a second tunable load; and
an isolator, wherein the second tunable load is operably connected to the third directional coupler and the isolator is connected between the second directional coupler and the third directional coupler, wherein the first directional coupler, the second directional coupler, and the third directional coupler being configured to reduce the interference comprise the second tunable load being tunable to reduce the interference between the second transceiver and the antenna port and the isolator being configured to reduce reflections between the second directional coupler and the third directional coupler.

20. The user element of claim 1, wherein the system further comprises:
a first tunable load operably connected to the first directional coupler, wherein the first directional coupler, the second directional coupler, and the third directional coupler being configured to reduce the interference comprise the first tunable load being tunable to reduce the interference between the first transceiver and the antenna port; and
an adjustment impedance, wherein the adjustment impedance is operably connected between the second directional coupler and the third directional coupler, wherein the first directional coupler, the second directional coupler, and the third directional coupler being configured to reduce the interference comprise the adjustment impedance being tunable to reduce the interference between the second transceiver and the antenna port by adjusting a phase and magnitude of an impedance of the adjustment impedance.
